(19) United States
(12) Patent Application Publication
(10) Pub. No.: US 2022/0234143 A1
(43) Pub. Date: Jul. 28, 2022

(54) LASER MACHINING METHOD AND LASER MACHINING DEVICE

(71) Applicant: MITSUBISHI HEAVY INDUSTRIES, LTD., Tokyo (JP)

(72) Inventors: Hiroki MORI, Tokyo (JP); Akiko INOUE, Tokyo (JP); Saneyuki GOYA, Tokyo (JP)

(21) Appl. No.: 17/615,706

(22) PCT Filed: Jun. 5, 2019
(86) PCT No.: PCT/JP2019/022400

§ 371 Date: Dec. 1, 2021

(51) Int. Cl. B23K 26/38; B23K 26/402; B23K 26/035

(52) U.S. Cl. CPC B23K 26/38; B23K 2103/16; B23K 26/035; B23K 26/402

(57) ABSTRACT

A method for performing cutting machining by applying a laser beam to the surface of a base material formed from a composite material and cutting the base material to be cut out a product from the base material, a machining line, serving as a boundary between the product to be cut out and a remainder which is the base material after the product is cut out, is set to the base material before the cutting machining, and a plurality of machining paths along the machining line are set to be arranged from the machining line side to the remainder side with the machining line side as a reference. In the cutting machining, the base material is cut by repeatedly executing a laser beam application step for applying the laser beam to the surface of the base material on the basis of the plurality of machining paths having been set.

### TECHNICAL FIELD

The present invention relates to a laser machining method and a laser machining device for performing machining on a composite material by irradiating the composite material with a laser.

### BACKGROUND ART

In the related art, a laser machining method for a composite material is known as follows. According to the laser machining method, a first step of irradiating a machining target site of the composite material with a high output power laser beam in a multiple line shape at a high swept speed through a plurality of paths is performed. In response to a progress of the first step, a second step of reducing a multiple line degree is performed when a machining depth gradually increases (for example, refer to PTL 1).

### CITATION LIST

### Patent Literature

[PTL 1] Japanese Unexamined Patent Application Publication No. 2016-107574

### SUMMARY OF INVENTION

### Technical Problem

According to the laser machining method in PTL 1, in the first step, machining is performed in multiple lines disposed around a machining line as a center, and in the second step, machining is performed by reducing the multiple line degree. Therefore, in the laser machining method in PTL 1, a cutting groove has a V-shape formed around the machining line as the center (that is, a tapered shape in which a groove width is narrowed as the machining depth increases). Therefore, when the machining line is set in an end portion on a product side, a portion on the product side (front surface side) is removed by the laser. In addition, when the machining is performed by sliding a position of the machining line to be away from the product side in order to avoid the portion on the product side (front surface side) from being removed by the laser, a remaining portion is formed on the product side (rear surface side). Consequently, when a vertical cutting surface is required, it is necessary to perform post processing.

Therefore, an object of the present invention is to provide a laser machining method and a laser machining device which can form a highly accurate machining surface.

### Solution to Problem

According to the present invention, there is provided a laser machining method in which a product is cut out from a base material formed of a composite material. The laser machining method includes performing cutting machining for cutting the base material by irradiating a front surface of the base material with a laser. In the base material before the cutting machining, a machining line is set as a boundary between the product to be cut out and a remaining portion which is the base material after the product is cut out. A plurality of machining paths extending along the machining line are set to be aligned from the machining line side to the remaining portion side, while the machining line side serves as a reference. During the cutting machining, the base material is cut by repeatedly performing a laser irradiation step of irradiating the base material with the laser, based on the plurality of set machining paths.

According to the configuration, the base material can be irradiated with the laser through the plurality of machining paths while the machining line side serves as the reference. Accordingly, a product surface of a product cut out from the base material can be used as a machining surface extending along the machining line. Therefore, when the machining line is a line extending along a thickness direction of the base material, the product surface of the product does not need to be a tapered surface tilted in the thickness direction, and can become the product surface extending along the machining line.

In addition, it is preferable to adopt a configuration as follows. In the laser irradiation step, the base material is irradiated with the laser through the plurality of machining paths from the machining line side toward the remaining portion side.

According to the configuration, heat can be prevented from being transferred to the product side. Accordingly, the heat can be prevented from affecting the product side.

In addition, it is preferable to adopt a configuration as follows. In the repeatedly performed laser irradiation step, the base material is irradiated with the laser by aligning a focus of the laser in the current laser irradiation step with a machining surface formed in the previous laser irradiation step.

According to the configuration, even when the machining surface of the base material formed by irradiating the base material with the laser in the previous laser irradiation step becomes deeper in the irradiation direction of the laser, the focus of the laser in the current laser irradiation step can be aligned with the machining surface of the base material. Therefore, the base material can be properly irradiated with the laser in the current laser irradiation step.

In addition, it is preferable to adopt a configuration as follows. In the repeatedly performed laser irradiation step, the number of the machining paths in the current laser irradiation step is smaller than the number of the machining paths in the previous laser irradiation step.

According to the configuration, the machining paths of the laser irradiation step can be reduced. Accordingly, a machining time can be shortened.

In addition, it is preferable to adopt a configuration as follows. During the cutting machining, an irradiation direction of the laser is tilted with respect to a depth direction from the front surface toward the rear surface of the base material of the machining line, in a cross section perpendicular to an extending direction in which the machining line extends on the front surface of the base material.

According to the configuration, the irradiation direction of the laser is tilted with respect to the machining line. In this manner, the machining surface can be prevented from being tilted with respect to the machining line, and can become the machining surface extending along the machining line.

According to the present invention, there is provided a laser machining device that cuts out a product from a base material formed of a composite material by irradiating a front surface of the base material with a laser and performing cutting machining for cutting the base material. The laser machining device includes a laser irradiation unit that irradiates the front surface of the base material with the laser, a laser scanner that scans the front surface of the base material with the laser, and a control unit that controls operations of the laser irradiation unit and the laser scanner. In the base material before the cutting machining, a machining line is set as a boundary between the product to be cut out and the remaining portion which is the base material after the product is cut out. A plurality of machining paths extending along the machining line are set to be aligned from the machining line side to the remaining portion side, while the machining line side serves as a reference. The control unit performs the cutting machining for cutting the base material by repeatedly performing a laser irradiation step of irradiating the base material with the laser, based on the plurality of set machining paths.

According to the configuration, the base material can be irradiated with the laser through the plurality of machining paths from the machining line side toward the remaining portion side. Accordingly, the product surface of the product cut out from the base material can be used as the machining surface extending along the machining line. Therefore, when the machining line is a line extending along a thickness direction of the base material, the product surface of the product does not need to be a tapered surface tilted in the thickness direction, and can become the product surface extending along the machining line.

In addition, it is preferable to adopt a configuration as follows. The laser machining device further includes a laser tilting unit that tilts an irradiation direction of the laser with respect to a depth direction from the front surface toward a rear surface of the base material of the machining line, in a cross section perpendicular to an extending direction in which the machining line extends on the front surface of the base material.

According to the configuration, the irradiation direction of the laser is tilted with respect to the machining line. In this manner, the machining surface can be prevented from being tilted with respect to the machining line, and can become the machining surface extending along the machining line.

### BRIEF DESCRIPTION OF DRAWINGS

FIG. 1 is a view schematically illustrating a laser machining device according to Embodiment 1.

FIG. 2 is a view for describing a laser machining method according to Embodiment 1.

FIG. 3 is a view schematically illustrating a laser machining device according to Embodiment 2.

FIG. 4 is a view for describing a laser machining method according to Embodiment 2.

### DESCRIPTION OF EMBODIMENTS

Hereinafter, embodiments according to the present invention will be described in detail with reference to the drawings. The present invention is not limited by the embodiments. In addition, configuration elements in the following embodiments include those which can be easily replaced by those skilled in the art, or those which are substantially the same. In addition, the configuration elements described below can be appropriately combined with each other, and when there are a plurality of the embodiments, the embodiments can be combined with each other.

### Embodiment 1

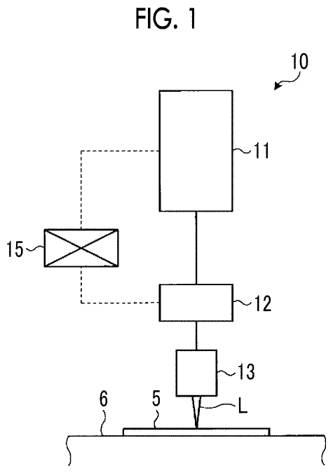

FIG. 1 is a view schematically illustrating a laser machining device according to Embodiment 1. As illustrated in FIG. 1, a laser machining device 10 according to Embodiment 1 is a device that can cut a composite material 5 by irradiating the composite material 5 serving as a machining object with a laser L.

For example, the composite material 5 includes fiber reinforced plastics such as carbon fiber reinforced plastic (CFRP), glass fiber reinforced plastic (GFRP), and glass long fiber reinforced plastic (GMT).

As illustrated in FIG. 1, a laser machining device 10 includes a laser irradiation device 11, a scanning optical system 12, a light condensing optical system 13, a support base 6, and a control unit 15.

The laser irradiation device 11 is a device that outputs the laser L. The laser irradiation device 11 may use a pulse wave (continuous wave) or a continuous wave (CW) as the laser L to be output. In Embodiment 1, it is preferable to use the laser irradiation device 11 that irradiates the composite material 5 with the laser L having the continuous wave capable of continuously supplying energy. In addition, the laser irradiation device 11 may irradiate the composite material 5 with the laser L in a single mode or a multi-mode. In Embodiment 1, it is preferable to use the laser irradiation device 11 that irradiates the composite material 5 with the laser L in a single mode having a high light condensing property.

The scanning optical system 12 is an optical system that scans the composite material 5 with the laser L emitted for irradiation from the laser irradiation device 11. The scanning optical system 12 includes a scanner capable of operating the laser inside the front surface of the composite material 5. For example, as the scanner, a galvanometer mirror is used.

The light condensing optical system 13 is an optical system that condenses the laser L emitted from the scanning optical system 12 at a focus, and irradiates the composite material 5 with the condensed laser L. The light condensing optical system 13 is configured to include an optical member such as a light condensing lens.

The support base 6 supports the composite material 5 at a predetermined position. The support base 6 may be a moving stage for moving the composite material 5 within a horizontal plane. The front surface of the composite material 5 disposed in the support base 6 is substantially perpendicularly irradiated with the laser L emitted for irradiation from the laser irradiation device 11.

The control unit 15 is connected to each unit including the laser irradiation device 11 and the scanning optical system 12, and controls an operation of the laser machining device 10 by controlling each unit. For example, the control unit 15 adjusts irradiation conditions of the laser L emitted for irradiation from the laser irradiation device 11 by controlling the laser irradiation device 11. In addition, for example, the control unit 15 controls a scanning operation of the laser L on the front surface of the composite material 5 by controlling the scanning optical system 12.

The laser machining device 10 configured as described above irradiates the composite material 5 with the laser L emitted from the laser irradiation device 11, and guides the laser L emitted for irradiation to the scanning optical system 12. The laser machining device 10 changes an irradiation position of the laser L on the front surface of the composite material 5 by scanning the front surface of the composite material 5 with the laser L incident on the scanning optical system 12. The laser machining device 10 causes the laser L emitted from the scanning optical system 12 to be incident on the light condensing optical system 13, and irradiates the composite material 5 with the condensed laser L.

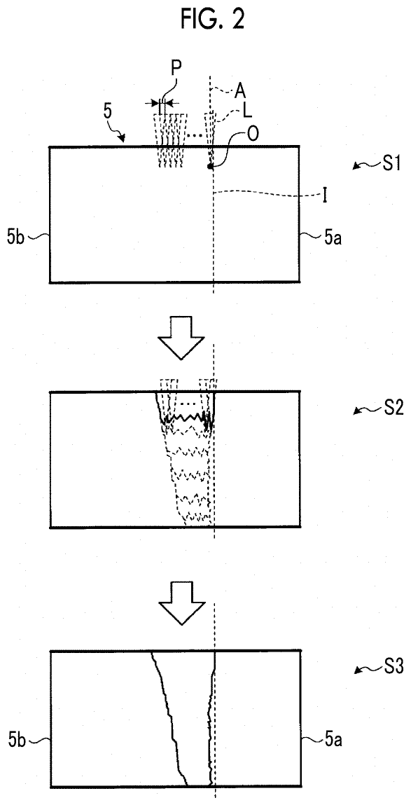

Next, a laser machining method for cutting the composite material 5 by using the above-described laser machining device 10 will be described with reference to FIG. 2. FIG. 2 is a view for describing the laser machining method according to Embodiment 1. Here, for example, the composite material 5 has a plate thickness of 10 mm or larger.

In the laser machining method, the composite material 5 is used as a base material (hereinafter, also referred to as a base material 5), and cutting machining for cutting the base material 5 is performed to cut out a product 5a from the base material 5. Therefore, the cutting machining is performed on the base material 5 to form a cut-out product 5a and a remaining portion 5b which is the base material 5 after the product 5a is cut out. In addition, in the laser machining method, a machining line I serving as a boundary between the product 5a and the remaining portion 5b is set in advance in the base material before the cutting machining.

As illustrated in FIG. 2, the base material 5 has a flat plate shape, and a direction in which the front surface and the rear surface face each other is a thickness direction (upward-downward direction in FIG. 2). Then, a direction in which the machining line I extends on the front surface of the base material 5 is an extending direction. In a cross section perpendicular to the extending direction, a direction from the front surface toward the rear surface of the base material 5 is a depth direction. The depth direction of the machining line I is the upward-downward direction in FIG. 2, and is a line extending along the thickness direction of the base material 5, for example. In addition, the extending direction of the machining line I is the depth direction in FIG. 2.

In addition, a plurality of machining paths are set in the base material 5 (Step S1). The plurality of machining paths are set to be aligned in a width direction (rightward-leftward direction in FIG. 2) perpendicular to the thickness direction (depth direction) and the depth direction (extending direction). Specifically, in the width direction, the plurality of machining paths are set to be aligned at a predetermined pitch interval P from the machining line I side to the remaining portion 5b side, while the machining line I side serves as a reference. That is, the machining path on the machining line I side is located at a constant position regardless of the depth direction of the machining line I. In addition, as illustrated in FIG. 2, a focus O of the laser L is located inside the base material 5, and an optical axis A of the laser L extends along the thickness direction of the base material 5.

During the cutting machining, a laser irradiation step of irradiating the front surface of the base material 5 with the laser L is repeatedly performed through a plurality of machining paths from the machining line I side toward the remaining portion 5b side (Step S2). That is, in the laser irradiation step, the base material 5 is scraped each time by a predetermined thickness, and the laser irradiation step is performed a plurality of times. In this manner, the base material 5 is scraped and penetrated from the front surface to the rear surface, thereby cutting the base material 5. In this way, during the cutting machining, the front surface of the base material 5 is irradiated with the laser L, while the machining line I side serves as a starting end side of the machining path and the remaining portion 5b side serves as a terminal side of the machining path.

Here, irradiation conditions of the laser L in each laser irradiation step are the same irradiation conditions. On the other hand, with regard to the number of machining paths in the laser irradiation step, the path number of machining paths in the current (subsequent) laser irradiation step is smaller than the path number of machining paths in the previous (current) laser irradiation step. That is, the path number of machining paths on a deep side in the thickness direction of the base material 5 is smaller than the path number of machining paths on a shallow side. Therefore, during the cutting machining, when the pitch intervals P in each laser irradiation step are the same as each other, the base material 5 is irradiated with the laser L so that a cutting width in the width direction is narrowed from the front surface side (shallow side) toward the rear surface side (deep side) of the base material 5.

In addition, in the cutting step, in the laser irradiation step, the focus O of the laser L in the current laser irradiation step is aligned with the machining surface formed in the previous laser irradiation step. In this manner, the base material 5 is irradiated with the laser L. That is, a position of the focus O of the laser L in the current laser irradiation step is a deeper position in the depth direction than a position of the focus O of the laser L in the previous laser irradiation step.

In the product 5a cut out after the cutting machining, the machining surface irradiated with the laser L is formed as a surface following the machining line I (Step S3).

As described above, according to Embodiment 1, the base material 5 can be irradiated with the laser L through the plurality of machining paths, while the machining line I side serves as a reference. Accordingly, the product surface of the product 5a cut out from the base material 5 can be used as the machining surface extending along the machining line I. That is, the machining line I is a line extending along the thickness direction of the base material. Accordingly, the product surface of the product 5a does not need to be a tapered surface tilted in the thickness direction, and can become the machining surface extending along the machining line I.

In addition, according to Embodiment 1, in the laser irradiation step, the base material 5 can be irradiated with the laser L through the plurality of machining paths from the machining line I side toward the remaining portion 5b side. Therefore, heat can be prevented from being transferred to the product 5a side, and the heat can be prevented from affecting the product 5a side.

In addition, according to Embodiment 1, the base material 5 can be irradiated with the laser L by aligning the focus O of the laser L in the current laser irradiation step with the machining surface formed in the previous laser irradiation step. Therefore, even when the machining surface of the base material 5 formed by irradiating the base material 5 with the laser L in the previous laser irradiation step becomes deeper in the irradiation direction of the laser L, the focus O of the laser L in the current laser irradiation step can be aligned with the machining surface of the base material 5. Therefore, the base material 5 can be properly irradiated with the laser L in the current laser irradiation step.

In addition, according to Embodiment 1, as an irradiation position of the laser for irradiating the base material 5 becomes deeper, the path number of machining paths can be reduced. Accordingly, a machining time can be shortened.

In Embodiment 1, an interval between the plurality of machining paths is not particularly described. However, for example, the pitch intervals P between the machining paths may be the same as each other. According to the configuration, a machining depth formed by the laser irradiation can be a uniform depth by preventing the machining depth from being unevenly distributed in the width direction of the cutting width.

In addition, in Embodiment 1, as the irradiation position of the laser L for irradiating the base material 5 becomes deeper, the path number of machining paths is reduced. However, without being particularly limited, the path number of machining paths may be the same path number in each laser irradiation step.

### Embodiment 2

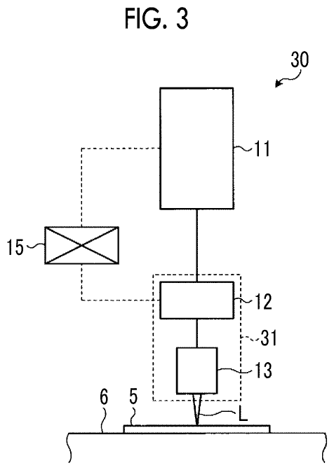

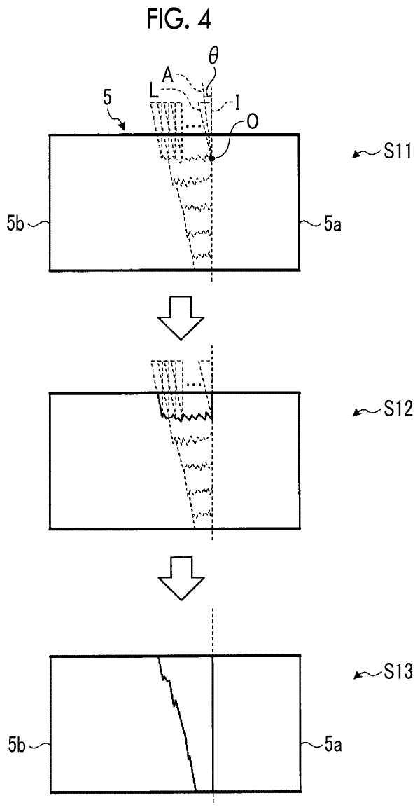

Next, a laser machining device and a laser machining method according to Embodiment 2 will be described with reference to FIGS. 3 and 4. In Embodiment 2, in order to avoid repeated description, elements different from those in Embodiment 1 will be described, and description will be made by assigning the same reference numerals to elements having configurations the same as those in Embodiment 1. FIG. 3 is a view schematically illustrating the laser machining device according to Embodiment 2. FIG. 4 is a view for describing the laser machining method according to Embodiment 2.

The laser machining device 30 of Embodiment 2 further includes a laser tilting unit 31 that relatively tilts the laser L with respect to the base material 5 in the laser machining device 10 of Embodiment 1. Embodiment 2 adopts a configuration in which the base material 5 is fixed and the laser L is tilted. However, a configuration may be adopted so that the laser L is fixed and the base material 5 is movable. The laser tilting unit 31 tilts the laser L with respect to the machining line I by tilting the scanning optical system 12 and the light condensing optical system 13. Specifically, in a cross section in FIG. 4 which is perpendicular to the extending direction in which the machining line I extends on the front surface of the base material 5, the laser tilting unit 31 tilts the optical axis A of the laser L with respect to the depth direction from the front surface toward the rear surface of the base material 5 of the machining line I. The laser tilting unit 31 may physically tilt at least one of the scanning optical system 12 and the light condensing optical system 13, or may tilt the laser L by an optical member included in the scanning optical system 12 or the light condensing optical system 13. A configuration is not particularly limited.

As illustrated in FIG. 4, the focus O of the laser L tilted by the laser tilting unit 31 is located inside the base material 5, and is condensed at a predetermined angle θ with respect to the optical axis A. Then, the optical axis A of the laser L is tilted with respect to the depth direction of the machining line I. That is, in view of the predetermined angle θ for condensing the laser L, a tilt angle of the optical axis A is set with respect to the depth direction of the machining line I. The tilt angle is set in a range of 0.1° to 5°, preferably in a range of 0.1° to 2°, and more preferably in a range of 0.1° to 1°.

During the cutting machining of Embodiment 2, the plurality of machining paths in which the laser L is tilted are set in the base material 5 (Step S11). As in Embodiment 1, the plurality of machining paths are set to be aligned along the width direction (rightward-leftward direction in FIG. 4) perpendicular to the thickness direction and the depth direction.

During the cutting machining, as in Embodiment 1, the laser irradiation step of irradiating the front surface of the base material 5 with the laser L is repeatedly performed through the plurality of machining paths from the machining line I side toward the remaining portion 5b side (Step S12).

In the product 5a cut out after the cutting machining, the machining surface irradiated with the laser L is formed as a surface that further follows the machining line I than in Embodiment 1 (Step S13).

As described above, according to Embodiment 2, the irradiation direction (optical axis A) of the laser L is tilted with respect to the machining line I. In this manner, the machining surface can be prevented from being tilted with respect to the machining line I, and can become the machining surface extending along the machining line I.

### REFERENCE SIGNS LIST

5: Composite material
5a: Product
5b: Remaining portion
6: Support base
10: Laser machining device
11: Laser irradiation device
12: Scanning optical system
13: Light condensing optical system
15: Control unit
L: Laser
I: Machining line
P: pitch interval
O: focus
A: Optical axis

1. A laser machining method in which a product is cut out from a base material formed of a composite material, the method comprising performing cutting machining for cutting the base material by irradiating a front surface of the base material with a laser,
wherein in the base material before the cutting machining, a machining line is set as a boundary between the product to be cut out and a remaining portion which is the base material after the product is cut out,
a plurality of machining paths extending along the machining line are set to be aligned from the machining line side to the remaining portion side, while the machining line side serves as a reference, and
during the cutting machining, the base material is cut by repeatedly performing a laser irradiation step of irradiating the base material with the laser, based on the plurality of set machining paths.

2. The laser machining method according to claim 1,
wherein in the laser irradiation step, the base material is irradiated with the laser through the plurality of machining paths from the machining line side toward the remaining portion side.

3. The laser machining method according to claim 1,
wherein in the repeatedly performed laser irradiation step, the base material is irradiated with the laser by aligning a focus of the laser in the current laser irradiation step with a machining surface formed in the previous laser irradiation step.

4. The laser machining method according to claim 1,
wherein in the repeatedly performed laser irradiation step, the number of the machining paths in the current laser irradiation step is smaller than the number of the machining paths in the previous laser irradiation step.

5. The laser machining method according to claim 1,
wherein during the cutting machining, an irradiation direction of the laser is tilted with respect to a depth direction from the front surface toward the rear surface of the base material of the machining line, in a cross section perpendicular to an extending direction in which the machining line extends on the front surface of the base material.

6. A laser machining device that cuts out a product from a base material formed of a composite material by irradiating a front surface of the base material with a laser and performing cutting machining for cutting the base material, the laser machining device comprising:
a laser irradiation unit that irradiates the front surface of the base material with the laser;
a laser scanner that scans the front surface of the base material with the laser; and
a control unit that controls operations of the laser irradiation unit and the laser scanner,
wherein in the base material before the cutting machining, a machining line is set as a boundary between the product to be cut out and the remaining portion which is the base material after the product is cut out,
a plurality of machining paths extending along the machining line are set to be aligned from the machining line side to the remaining portion side, while the machining line side serves as a reference, and
the control unit performs the cutting machining for cutting the base material by repeatedly performing a laser irradiation step of irradiating the base material with the laser, based on the plurality of set machining paths.

7. The laser machining device according to claim 6, further comprising:
a laser tilting unit that tilts an irradiation direction of the laser with respect to a depth direction from the front surface toward a rear surface of the base material of the machining line, in a cross section perpendicular to an extending direction in which the machining line extends on the front surface of the base material.
